(19) United States
(12) Patent Application Publication
(10) Pub. No.: US 2003/0127331 A1
(43) Pub. Date: Jul. 10, 2003

(54) Two-dimensional electrophoresis method and cassette

(76) Inventor: George T. Leka, Trumbull, CT (US)

Correspondence Address: Attorney John R. Doherty, P.O. Box 706, Stevenson, CT, 06491-0706, US

(21) Appl. No.: 10/340,364

(22) Filed: Jan. 9, 2003

Related U.S. Application Data
(60) Provisional application No. 60/347,030, filed on Jan. 10, 2002.

(51) Int. Cl. G01N 27/453

(52) U.S. Cl. 204/466; 204/546; 204/616; 204/641

(57) ABSTRACT

A method and device are provided for separating a sample, such as a protein, into its components by two-dimensional electrophoresis wherein instead of bringing the first separation medium, e.g., a fragile elongated gel strip, into contact with a second separation medium, e.g., a gel slab, after the former has been subjected to electrophoresis, the second separation medium is formed or cast in place along the length of the first separation medium only after the latter has undergone electrophoresis separation.

### FIELD OF THE INVENTION

The present invention relates to electrophoresis in general and more particularly to two-dimensional electrophoretic separation of a sample into its components.

### BACKGROUND OF THE INVENTION

A number of diagnostic procedures and laboratory tests are now carried out wherein samples, such as proteins, are separated according to their physical and chemical properties by way of electrophoresis. This process is used, for example, to analyze DNA molecules according to their size after being exposed to enzymes.

Electrophoresis separation is typically performed in a separation medium such as a gel. The gel may be agarose or poly-acrylamide, for example, and may be cast in an open tray or in the form of a slab between glass plates. Electrodes are connected to opposite ends of the gel which are then exposed to electrically conducting buffer solutions, one positively charged at one end of the gel and the other negatively charged at the other end. When connected to a power source, the resulting electric field that sets up across the gel forces the negatively charged molecules of the sample to migrate toward the positive electrode and the positively charged molecules of the sample to migrate in the opposite direction toward the negative electrode, dividing the sample into its components in the form of solute zones across the length of the gel.

In recent years, researchers have developed a two-dimensional electrophoresis process which provides a more detailed resolution of the sample components than is possible in one-dimension separation. This process effectively permits component mixtures to be separated according to two different sets of properties or characteristics. The first dimensional separation is typically carried out in an elongated rod-shaped gel with separation of the sample components occurring along the length of the rod. The second dimensional separation is then carried out by placing the rod-shaped gel along one edge of a slab gel and imposing an electric current across the rod and slab in a direction substantially perpendicular or transverse to the axis of the rod. Each solute zone present in the rod-shaped gel is caused to separate from the gel into the slab, effecting a further separation of each component into additional zones which can then be analyzed.

The major problem so far encountered when using two-dimensional electrophoresis resides in the handling of the rod-shaped gel after the first dimension separation has occurred. The rod-shaped gel is usually cast in an elongated tube and remains in the tube throughout electrophoresis and until the first dimension separation has been completed. The rod-shaped gel is then removed from the tube and placed into contact with the slab gel. Once removed from the tube, the rod shaped gel is totally unsupported and being very fragile is often damaged and lost. If not altogether destroyed, distortion of the solute zones may also occur during transport of the rod to the slab gel. Moreover, it is difficult, if not impossible, in some cases, to properly align the rod-shaped gel with the slab gel so as to achieve good electrical continuity between the two gels. Unless the two gels make good electrical contact along the entire length of the rod-shaped gel, some of the solute zones will fail to migrate and will be lost, severely compromising the entire process.

U.S. Pat. No. 5,773,645 entitled “Two-Dimensional Electrophoresis Device”, issued to Hochstrasser on Jun. 30, 1998, discloses a pre-cast two-dimensional gel system wherein the gel medium for each of the two dimensional separations are retained on a common support. The first dimensional gel is an elongated strip arranged to receive an electric current in the longitudinal direction of the strip while the second is a slab with an edge facing the strip and preferably parallel to it. The strip and slab are isolated from each other by a barrier that is both fluid-impermeable and electrically insulating and which is removable. The barrier serves to preclude electrophoresis taking place in the slab while the first strip undergoes electrophoretic separation. Once the first dimension separation has been performed by subjecting the strip to an electric field, the barrier is removed and the two gels are placed in contact with one another to start the second dimension separation.

Although this two-dimensional electrophoresis system addresses some of the limitations of prior art systems by reducing the amount of handling required to place the two gels together, there still is required movement or transport of the fragile gel strip across the common support to contact the slab gel during which time damage to the strip or distortion of the solute zones can occur. Moreover, there is still the problem with this system of making good physical contact between the two gels to achieve proper electrical continuity at their interface to carry out the electrophoresis process.

### SUMMARY OF THE INVENTION

The present invention provides a novel and improved method of separating a sample, such as a protein, into its components by two-dimensional electrophoresis wherein instead of bringing the first separation medium, e.g., a fragile elongated gel strip, into contact with a second separation medium, e.g., a gel slab, after the former has been subjected to electrophoresis, the opposite is the case in carrying out the method of the present invention. In the present method, the second separation medium, e.g., the gel slab, is formed or cast in place along the length of the first separation medium e.g., the elongated gel strip, only after the latter has undergone electrophoretic separation. Accordingly, in the case of the present method, there is no pre-casting of the second separation medium as in the prior art systems, which must be isolated from the first separation medium such as by using a barrier, during the electrophoresis process. In the present method, the gel slab is not yet formed or cast at the time the elongated gel strip undergoes electrophoresis. Moreover, since the gel slab is formed or cast in place next to and along the length of the gel strip, there are no problems encountered in handling the fragile gel strip while moving it into place adjacent to the gel slab as in systems of the prior art. Furthermore, since the second separation medium, e.g., the gel slab, is formed or cast from a liquid polymer while in contact with the first separation medium, e.g. the pre-cast gel strip, the likelihood of achieving good physical and electrical contact between the two gels after polymerization is significantly enhanced.

Briefly, a method for separating a sample into its components by two-dimensional electrophoresis according to the present invention comprising the steps of:

(a) forming an elongated strip composed of a first electrophoretic separation medium;

(b) loading the sample onto said elongated strip;

(c) imposing an electric field across the elongated strip to divide the sample components into zones spaced along the strip;

(d) forming a slab composed of a second electrophoretic separation medium in contact with the elongated strip; and

(f) imposing an electric field across both the elongated strip and the slab in a direction substantially perpendicular to the strip to effect electrophoretic separation of the zones in the slab.

The method of the present invention is carried out using a receptacle whose shape and dimensions are amenable, first of all, to casting the first separation medium, e.g., the elongated gel strip, in place within a portion of the receptacle and then subjecting it to electrophoretic separation by imposing an electrical field across its length. Since the first separation medium or gel strip must be elongated in form in order to accommodate the number of solute zones that are produced during electrophoresis, the receptacle should have an elongated dimension such as, for example, the bottom end of a generally rectangularly shaped vessel to act as a form or support for holding the liquid polymer during polymerization or casting of the gel strip. The vessel should also be of such size and configuration as to hold the liquid polymer for casting the gel slab after electrophoresis separation of the gel strip has occurred.

Ideally, the method of the invention is best carried out using a thin generally rectangularly shaped cassette made of two glass or plastic plates spaced apart and sealed along two opposite side edges to provide a small or narrow gap therebetween. The upper end of the cassette is left open to introduce the polymer solutions for casting both the elongated gel strip and gel slab and also for performing the electrophoresis process. The bottom end of the cassette is closed and sealed during the casting operation such as by use of a liquid impermeable sealing tape or other sealing device and which also must be removable. A molded plastic electrophoresis cassette having a sealed, break-away bottom end is disclosed and claimed in U.S. Pat. No. 5,411,657, issued to George T. Leka on May 2, 1995 and is ideally suited for use in carrying out the method of the present invention.

Thus, in accordance with the present invention, the first electrophoretic separation medium, e.g., the elongated gel strip, is initially formed or cast in place across the elongated bottom end or edge of the narrow gap provided by the two glass or plastic plates just above the bottom sealed end of the cassette or the breakaway seal disclosed in the above referred to patent. The elongated gel strip may be formed, for example, by feeding the liquid polymer solution through the top open end of the cassette. The liquid polymer could also be fed from the top open end of the cassette then gently guided downward against the bottom of the gap using a comb-like device. The polymer remains against the bottom of the gap until polymerization is complete, forming the elongated gel strip.

A pair of buffer wells or chambers are provided in accordance with the present invention, one on each side of the cassette located in close proximity to each end of the elongated gel strip inside the gap. Each one of the wells or chambers communicates with each end of the elongated gel strip preferably via a pair of channels which carrying the buffer solution to each end of the gel strip, a dilute basic buffer solution, such as sodium hydroxide, from one of the wells and a dilute acidic buffer solution, such as phosphoric acid, from the opposite well. In order to electrically charge the buffer solutions in each well or chamber, a pair of electrodes suitably in the form of thin metal wires extend through small openings within each side of the cassette which openings communicate with the individual wells or chambers through suitable seals provided, for example, by liquid impermeable sealing tape.

Typically, cassettes made in accordance with the present invention are shipped by the manufacturer to the end user with the first electrophoretic separation medium, e.g., the elongated gel strip pre-cast in place at the bottom of the cassette. The cassettes may also be provided with dehydrated gel strips, i.e., immobilized pH gradient strips called “IPG” strips. The IPG strips may be re-hydrated within the bottom of the cassette. Empty cassettes could also be provided so the users could pour gels themselves. The user will then load the sample onto the gel strip through one of the buffer wells or chambers using a syringe or the like. The wells are then filled with the appropriate buffer solutions and with the electrodes connected to a power source, the sample is subjected to electrophoresis, thus separating the same into its components or zones along the length of the gel strip. The user then casts the second separation medium, e.g., the gel slab, by filling the narrow gap inside the cassette with the appropriate polymer solution and allowing it to polymerize in contact with the gel strip at the bottom of the cassette. Of course, one or more layers of gels can be formed on top of the strip gel. Once polymerization is complete, the seals are removed or broken away exposing both gels at the bottom of the cassette. The bottom of the cassette is then placed in a tray containing buffer solution and buffer solution is placed within the top open end of the cassette. Electrodes are placed within each buffer solution and connected across the appropriate terminals of a power source to effect electrophoresis separation of the sample into zones within the gel slab.

### BRIEF DESCRIPTION OF THE DRAWINGS

The present invention will now be described in greater detail with particular reference to the accompanying drawings which show the preferred embodiments thereof and wherein:

FIG. 1 is a front elevational view of a two-dimensional electrophoresis cassette in accordance with the invention;

FIG. 2 is a top view of the two-dimensional electrophoresis cassette shown in FIG. 1;

FIG. 3 is a side view, partly in cross-section, of the two-dimensional electrophoresis cassette shown in FIGS. 1 and 2;

FIG. 4 is an elevation view of the back plate used in the two-dimensional electrophoresis cassette according to the invention taken along the line A-A in FIG. 2;

FIG. 5 is a side view of a two-dimensional electrophoresis cassette similar to that shown in FIGS. 1-4 but without a break-away seal at the bottom of the cassette;

FIG. 6 is an enlarged elevational view of part of the back plate used in the two-dimensional electrophoresis cassette encircled at B in FIG. 4;

FIG. 7 is a cross-sectional view of part of the back plate used in the two-dimensional electrophoresis cassette according to the invention taken along the line C-C in FIG. 6;

FIG. 8 is a similar view taken along the line D-D in FIG. 6;

FIG. 9 is a similar view taken along the line E-E in FIG. 4; and

FIG. 10 is a front elevational view, partly in cross-section, showing the two-dimensional electrophoresis cassette according to the invention during separation of a protein sample in a conventional electrophoresis apparatus.

### DESCRIPTION OF PREFERRED EMBODIMENTS

Referring now to the drawing and particularly to FIGS. 1-4, there is shown a two-dimensional electrophoresis cassette 10 according to the invention. The cassette includes a thin, rectangular, molded plastic front plate 12 and a thin, rectangular, molded plastic back plate 14, both of which are essentially the same size, e.g., approximately 8 cm. tall by 10 cm. wide or 16 cm tall×18 cm wide in a typical embodiment. The front and back plates 12, 14 are preferably made by injection molding a suitable plastic material such as acrylic, acrylic based plastics and polystyrene, for example.

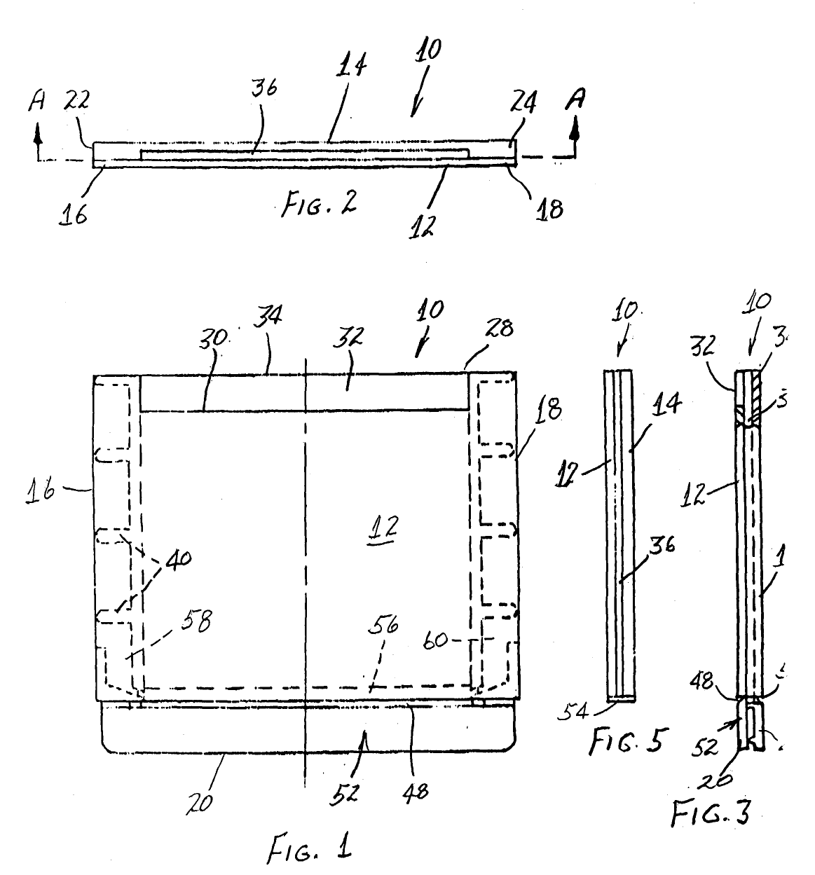

The front plate 12 overlies the back plate 14 with its two opposite side edges 16, 18 and its bottom edge 20 substantially coinciding with the respective side edges 22, 24 and the bottom edge 26 of the back plate 14 as probably best shown in FIG. 2. The top edge 28 of the front plate 12 is cut away as at 30 to provide a cassette opening 32. The cassette opening 32 is disposed below the top edge 34 of the back plate 14 as best seen in FIG. 1.

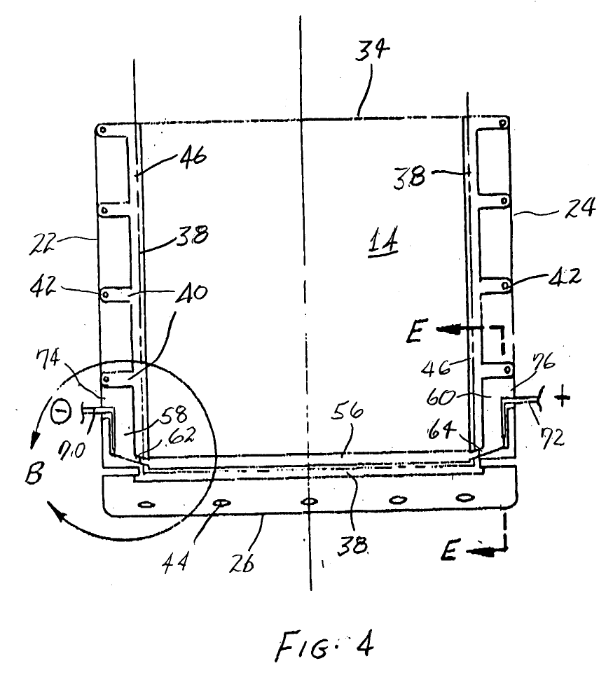

As shown in FIG. 4, the back plate 14 is integrally formed with an embossment on its surface facing the front plate 12 for spacing the two plates apart a fixed distance sufficient to provide a gap 36 for the gel media (see FIG. 2). In the embodiment of the cassette illustrated, the embossment is an elongated, narrow, substantially flat, generally U-shaped ridge 38. The ridge 38 extends continuously from the top edge 34 of the back plate 14 down along the left side edge 22, across the bottom portion of the plate 14 and then upwardly along the right side edge 24 to the top edge 34 of the plate.

Preferably, the embossed ridge 38 is spaced a distance above the bottom edge 26 of the plate 14 as shown in FIG. 4. The ridge 38 is also preferably spaced a distance inwardly from the opposite side edges 22, 24 of the plate 14.

The back plate 14 is also provided with a number of other embossments in addition to the ridge 38 to strengthen the cassette. Thus a series of ribs 40 may be formed which extend outwardly from the ridge 38 at spaced apart points along both side edges 22, 24 of the plate 14. The ribs 40 may also be formed with adjacent circular pads 42 which help to prevent bowing of the plates when the cassette is placed in existing electrophoresis apparatus. In addition, a plurality of oblong nibs 44 may be molded at spaced points along the bottom of the plate 14 to strengthen the cassette.

The cassette 10 is assembled by securing the front plate 12 to the back plate 14 along the U-shaped spacer ridge 38 preferably by ultrasonic welding. The energy director for forming the continuous ultrasonic weld along the ridge 38 is depicted at 46 in FIG. 4. The weld joins the two plates 12, 14 together and seals off the gap 36 against leakage of liquid during formation of the gel media.

Preferably, the front plate 12 is also ultrasonically welded to the series of ribs 40, circular pads 42 and the nibs 44 on the back plate 14, offering added strength to the cassette 10. It should be noted that the ribs 40 are integrally molded with the back plate 14 and protrude approximately to the same height as the spacer ridge 38. The circular pads 42 and the nibs 44 are also integral with the plate 14 but protrude approximately to the height of the energy director and melt down to the level of the ridge 38 during welding. Once assembled, the cassette is typically about 0.5 cm. thick. It should also be noted that the weld provides a water-tight seal but the weld strength is weak enough to permit prying open of the two cassettes halves after electrophoresis.

An elongated, narrow, V-shaped groove 48 is provided within the outer surface of the front plate 12 as best seen in FIGS. 1 and 3. The groove 48 extends completely across the surface of the plate 12 at a point just above the ultrasonic weld 46. Similarly, an elongated, narrow, V-shaped groove 50 is provided within the outer surface of the back plate 14 as best seen in FIG. 3. This groove 50 also extends completely across the surface of the plate 14 at a point just above the ultrasonic weld 46 and coincides with the groove 48. The two grooves 48, 50 substantially weaken the plates 12, 14 at the bottom of the cassette and provide a tab 52 which can be easily broken off to expose the bottom of the gap 36.

Although the breakaway tab 52 is an advantageous feature to incorporate in the two-dimensional electrophoresis cassette of the present invention, it may be eliminated entirely and replaced by a more conventional tape seal as shown in FIG. 5. Thus, a liquid impermeable tape 54 may be placed across the lower edges of both the front and back plates 12, 14 to seal off the gap 36 at the bottom open end of the cassette 10.

Turning now more particularly to FIGS. 4 and 6-10 of the drawings, the two-dimensional electrophoresis cassette 10 further incorporates according to the present invention an elongated pre-cast gel strip 56. The gel strip 56 is positioned within the bottom of the gap 36 just above the lower section of the U-shaped spacer ridge 38. The gel strip 56 may be formed or cast in place by feeding the liquid polymer through the top opening 32 of the cassette and then gently guiding the polymer down along the length of the cassette until it reaches the bottom of the gap 36 where after a sufficient time it polymerizes or sets up ready for use.

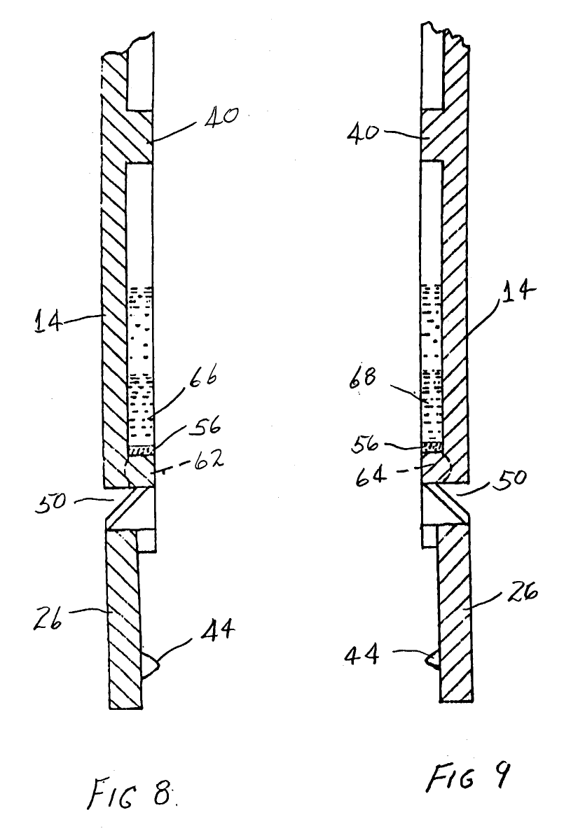

Preferably, as shown more particularly in FIG. 7, the section of the back wall 14 where the gel strip 56 is positioned at the bottom of the gap 36 is recessed to provide a rounded groove as at 57. The groove 57 helps to hold the gel strip 56 in place during use.

A pair of buffer wells or chambers 58, 60 are provided which hold the basic and acidic buffer solutions required for carrying out the first dimension electrophoretic separation. The buffer wells or chambers 58, 60 are located within the opposite marginal edge portions of the cassette 10, one adjacent to each opposite side edge 22, 24 of the back plate 14 in close proximity to the pre-cast gel strip 56. As best seen in the view of FIG. 4, the buffer well 58 on the left side of the cassette 10 communicates with one end of the gel strip 56 via a channel 62 while the buffer well 60 on the right side of the cassette communicates with the opposite end of the gel strip 56 via a channel 64. In the embodiment of the electrophoresis cassette 10 illustrated in the drawing, the buffer well 58 on the left side of the cassette 10 contains the negatively charged buffer solution 66 (see FIG. 8) while the buffer well 60 on the opposite left side of the cassette contains the positively charged buffer solution 68 (see FIG. 9).

A pair of electrodes 70, 72 in the form of thin wires are provided for connection to the appropriate terminals of a power source (not shown) for separately polarizing each one of the buffer solutions 66, 68. The wire electrode 70 extends at one end into contact with the buffer solution 66 through a small opening or slot 74 along the left edge 22 of the back wall 14. Similarly, the wire electrode 72 extends at one end into contact with the buffer solution 68 through a small opening or slot 76 along the right edge 24 of the back wall 14.

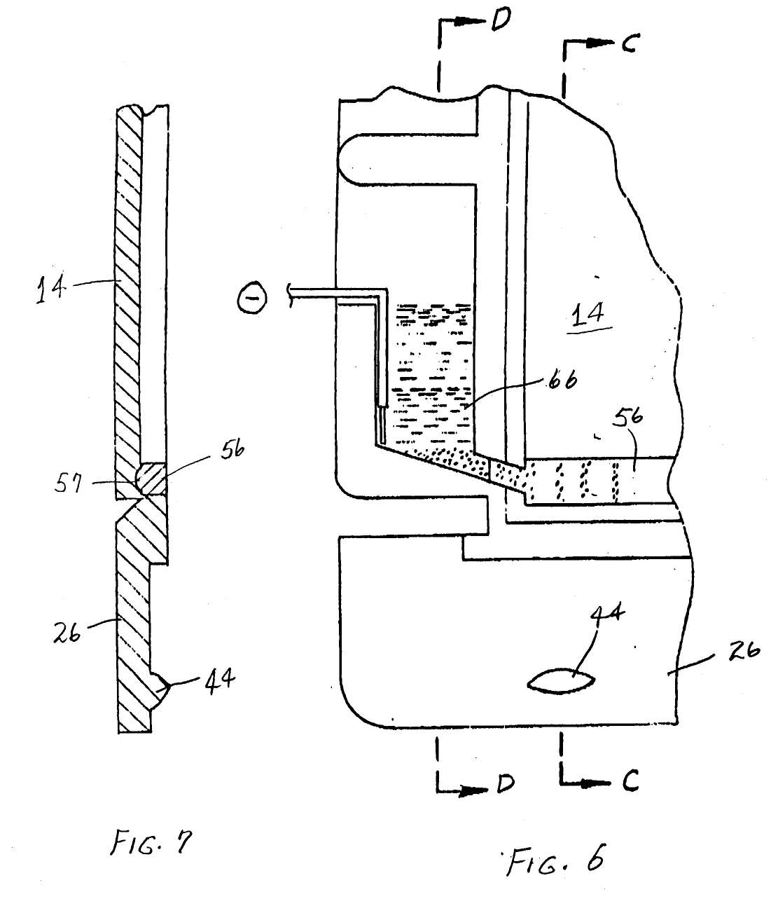

To perform the first dimension electrophoresis separation, the user first fills the two buffer wells or chambers 58, 60 with the appropriate buffer solutions through the slots 74, 76 using a syringe or other filling device. The wire electrode 72 which makes contact with the positively charged buffer solution is connected at its other end to the positive terminal of the power source. In the same manner, the wire electrode 70 which makes contact with the negatively charged buffer solution is connected at its other end to the negative terminal of the power source. The user then loads the sample 78, e.g., proteins, into the negatively charged buffer solution within the buffer well 58, allowing the first dimension separation to occur along the length of the gel strip 56 as generally depicted at 80 in the view of FIG. 6.

It should be noted that the two channels 62, 64 are inclined at an angle as shown in FIG. 4 which provides a ramp where sample may also be introduced. The angel can be any angle greater than zero degrees from horizontal and makes it possible to introduce sample into the cassette 10 that are run vertically or at any angle greater than zero degrees from horizontal.

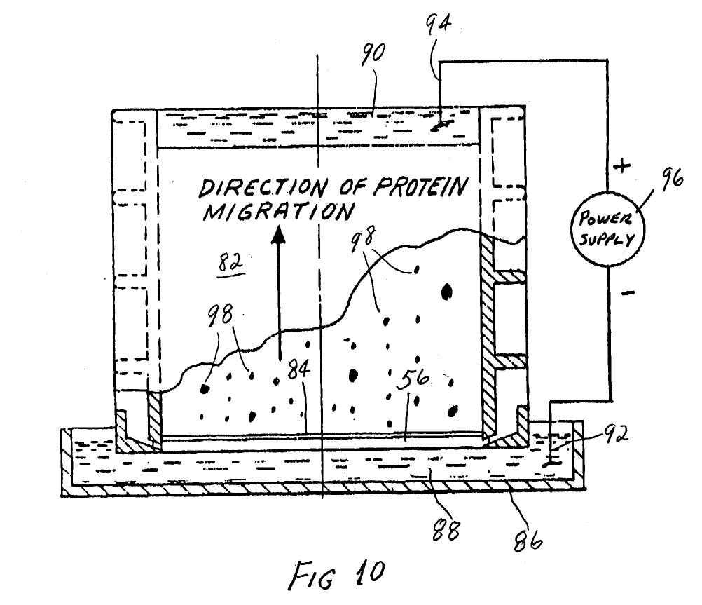

Once the first dimension separation has been completed, the user forms or casts the gel slab 82 (see FIG. 10) along the length of the gap 36 in contact with the gel strip 56 suitably by adding the liquid polymer through the top open end of the cassette 10. A thin layer of an agarose gel 84 may optionally be cast over the gel strip 56. After a sufficient time has elapsed to permit polymerization of the gel slab 82, the tab 52 at the bottom of the cassette 10 is broken away to expose the bottom of the gap 36 containing both the gel strip 56 and the gel slab 82. The cassette is then transferred to an electrophoresis apparatus for carrying out the second dimension separation as schematically shown in FIG. 10. As shown, the bottom of the cassette 10 is placed in a tray 86 containing a lower buffer solution 88 and an upper buffer solution 90 is placed within the top open end of the cassette 10. Electrodes 92, 94 are placed within the lower and upper buffer solutions 88, 90, respectively, and connected across the negative and positive terminals of a power source 96 to effect the second dimension separation of the sample into zones within the gel slab 82 as denoted at 98 in FIG. 10.

Thus, it will be seen that the present invention provides a significantly improved method and cassette for separating a sample into its components by two-dimensional electrophoresis. The cassette provides a design where the strip does not have to be moved in order to perform the second dimension separation. The gel strip can be treated with equilibration solution while it is still in the cassette prior to running the second dimension gel slab. Moreover, it should be noted that sample can be introduced at either end of the cassette or in the middle of the cassette. The electrodes can be part of the cassette or the electrodes can be part of the electrophoresis apparatus that runs the gels. Furthermore, it will be seen that the cassettes can be provided as empty cassettes with no gel so that the end users can pour the strip gel and slab gel themselves or provide an IPG strip for hydration. As shown in FIGS. 8 and 9, for example, the gel strip can be provided with a flat surface which interfaces well with the flat surface of the gel slab. Finally, it will be seen that the design of the present cassette is generic and that improvements in electrophoresis gel chemistries and methods can be easily applied thereto.

What is claimed is:

1. A method for separating a sample into its components by two-dimensional electrophoresis comprising the steps of:
(a) forming an elongated strip composed of a first electrophoretic separation medium;
(b) loading said sample onto said elongated strip;
(c) imposing an electric field across said elongated strip to divide the sample components into zones spaced along said strip;
(d) forming a slab composed of a second electrophoretic separation medium in contact with said elongated strip containing said zones; and
(f) imposing an electric field across both said elongated strip containing said zones and said slab in a direction substantially perpendicular to said strip containing said zones to effect electrophoretic separation of said zones in said slab.

2. A method for separating a sample according to claim 1, further providing a receptacle having an elongated dimension and forming said elongated strip along said elongated dimension of said receptacle.

3. An electrophoresis cassette for preforming two-dimensional separation of a sample into its components comprising, in combination: a pair of thin, flat plates overlying one another in opposing relationship and being separated from each other by a marginal seal to form a gap therebetween for holding a gel medium in the form of an elongated strip, said marginal seal including a pair of chambers located one on each side of said gap for holding a buffer solution and channel means communicating between said chambers and said gap for delivering said buffer solutions to both ends of said elongated strip.
